(19) United States
(12) Patent Application Publication
(10) Pub. No.: US 2026/0221573 A1
(43) Pub. Date: Jul. 30, 2026

(54) Electrical Device with a Rechargeable Battery Pack Interface

(71) Applicant: Robert Bosch GmbH, Stuttgart (DE)

(72) Inventors: Marcel Fuchs, Leinfelden-Echterdingen (DE); Andreas Strasser, Rudersberg (DE); Tobias Fischer, Leinfelden-Echterdingen (DE); Jakob Schoenbrodt, Bietigheim-Bissingen (DE); Thomas Speda, Holzgerlingen (DE); Tobias Mangold, Murrhardt (DE); Hansjoerg Beutel, Pfullingen (DE); Christian Wiedemann, Wiernsheim (DE); Fabian Schempp, Stuttgart (DE); Patrick Schlauch, Esslingen (DE); Jan Breitenbach, Stuttgart (DE); Annika Lerner, Walddorfhaeslach (DE)

(21) Appl. No.: 19/147,665

(22) PCT Filed: Jan. 9, 2024
(86) PCT No.: PCT/EP2024/050371

§ 371 Date: Jul. 11, 2025

(30) Foreign Application Priority Data
Jan. 12, 2023 (DE) 10 2023 200 211.6
Feb. 13, 2023 (DE) 10 2023 201 148.4

(51) Int. Cl. H01M 50/244; B25F 5/02; H01M 50/247

(52) U.S. Cl. CPC H01M 50/244; B25F 5/02; H01M 50/247; H01M 2220/30

(57) ABSTRACT

In an electrical device, in particular a hand-held power tool, having a housing and a battery pack interface on which a battery pack can be locked via a locking element associated with the battery pack, an operator element is arranged on the housing for directly impinging on the locking element of the battery pack in order to unlock the battery pack.

### PRIOR ART

The present invention relates to an electrical device, in particular to a hand-held power tool, having a housing and a battery pack interface, on which a battery pack can be locked via a locking element associated with the battery pack.

From the prior art, an electrical device configured as a hand-held power tool is known which comprises a housing and a battery pack interface for mounting a battery pack. The battery pack comprises a locking element via which it can be locked to the battery pack interface of the hand-held power tool. For unlocking, the battery pack comprises an operator element which, when actuated, impinges the locking element into an unlocking position.

### DISCLOSURE OF THE INVENTION

The invention relates to an electrical device, in particular to a hand-held power tool, having a housing and a battery pack interface on which a battery pack can be locked via a locking element associated with the battery pack. On the housing, there is arranged an operator element for directly impinging on the locking element of the battery pack for unlocking the battery pack.

The invention thus enables the provision of an electrical device, in which the operator element arranged on the housing allows for an easy and straightforward unlocking of a battery pack arranged on the electrical device. Thus, for example, in the case of a sluggish operator element of the battery pack, the battery pack can be unlocked via the operator element provided on the housing of the electrical device.

Preferably, the operator element is arranged on a handle formed by the housing.

Thus, an actuation of the operator element in a position of the electrical device commonly used during operation of the electrical device can be enabled on the handle, in which a user of the electrical device does not have to let go of the same or otherwise change their grip.

The operator element is preferably impinged into a rest position via a spring element.

Thus, the operator element can be impinged into the rest position in a simple manner.

The housing preferably forms a guide section for guiding the operator element.

Thus, a safe and reliable actuation of the operator element can be enabled.

Preferably, the operator element is configured as a pressure switch and is arranged between a handle formed by the housing and a receiving area of the housing associated with the battery pack interface.

Ergonomic and uncomplicated operation can thus be enabled.

According to one embodiment, the operator element is configured as a slider switch, wherein the operator element is movable into an unlocking position via a linear pushing or pulling motion.

Thus, a suitable operator element can be provided in a simple manner.

Preferably, the operator element comprises a ramp-like impingement portion for impinging on a locking element of a battery pack locked to the battery pack interface.

Thus, an easy and uncomplicated operation can be enabled.

Preferably, the operator element comprises an end stop configured so as to limit a travel distance of the operator element during a movement from a rest position into an unlock position.

Thus, a defined travel distance of the operator element can be simply and precisely specified.

Preferably, the travel distance is greater than an axial length of a locking element of a battery packed locked to the battery pack interface, which locking element is to be impinged.

Thus, a safe and reliable unlocking can be enabled.

Moreover, the present invention relates to a previously described electrical device having a battery pack. Here, the operator element of the electrical device is configured so as to impinge on a locking element of the battery pack, which is arranged on a battery pack locked to the battery pack interface. The battery pack comprises a second operator element configured to actuate the locking element of the battery pack.

The invention thus enables the provision of an electrical device with a battery pack, in which an easy and uncomplicated unlocking of the battery pack arranged on the electrical device can be enabled by two different operator elements.

Preferably, the operator element of the electrical device is configured so as to directly impinge on a locking element of the battery pack.

Thus, a force-reduced unlocking of the battery pack can be facilitated in an easy and uncomplicated manner, because a comparatively low actuation force is required for actuating the operator element due to the direct impingement.

Preferably, the locking element of the battery pack is mounted in a linearly and/or rotationally movable manner in or on the housing of the battery pack.

Thus, a suitable storage of the locking element can be easily and reliably enabled.

The locking element is preferably configured for a force-fit and/or form-fit connection, in particular via an undercut, of the battery pack to the electrical device.

Thus, a secure and robust connection of the battery pack to the electrical device can be enabled.

### BRIEF DESCRIPTION OF THE DRAWINGS

The invention is explained in more detail in the following description with reference to the exemplary embodiments shown in the drawings. The figures show:

FIG. 1 a partially schematic perspective view of an electrical device having a handle on which a battery pack is arranged,

FIG. 2 a sectional view of a portion of the handle with the battery pack of FIG. 1 locked thereon, with an operator element in a rest position,

FIG. 3 the sectional view of FIG. 2 with the operator element in an unlocking position,

FIG. 4 a schematic view of the battery pack of FIG. 1 arranged on the electrical device of FIG. 1, with an alternative operator element according to a further embodiment in the rest position, and

FIG. 5 a schematic view of the electrical device with the battery pack arranged thereon according to FIG. 4, with a further operator element in the rest position.

### DESCRIPTION OF THE EXEMPLARY EMBODIMENTS

Elements having the same or a comparable function are provided with the same reference signs in the figures and are described in detail only once.

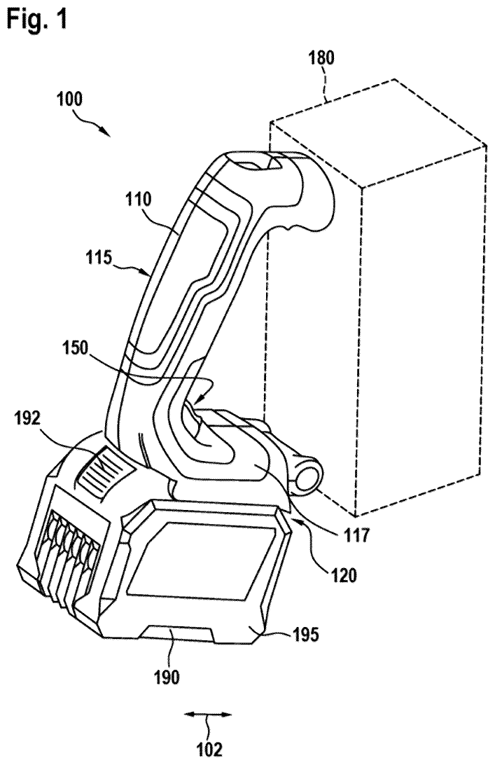

FIG. 1 illustrates, by way of example, an electrical device 100 having a housing 110, 180. The electrical device 100 is illustratively configured as a hand-held power tool and is therefore described in detail below as an example in order to illustrate a possible realization of the present invention with respect to a hand-held power tool. It is noted, however, that the present invention is not limited to hand-held power tools, but rather, the electrical device 100 can also be configured as a garden tool, radio, work site light, electric bicycle, etc.

The housing 110, 180 preferably comprises a main housing portion 180, in which a drive unit (not shown) is preferably arranged, e.g. for driving a tool holder (not shown). The main housing portion 180 is preferably connected to a handle housing portion 110, forming a handle 115 according to the illustration. The handle 115 is configured so as to hold the hand-held power tool 100. For example, the handle 115 is arranged at an angle to the main housing portion 180.

The main housing portion 180 and the handle housing portion 110 can either be designed as one piece, i.e. as an integral overall housing, or as two pieces, i.e. as two separate housings. By way of example, the main housing portion 180 will hereinafter be referred to merely as “the housing 180” and the handle housing portion 110 will be referred to merely as “the housing 110.”

The housing 110 or the handle 115 is preferably associated with a receiving area 117. The receiving area 117 is associated with a battery pack interface 120 according to the illustration. Preferably, a battery pack 190 for powering the hand-held power tool 100 in an off-grid manner can be arranged on the battery pack interface 120. The battery pack interface 120 allows the battery pack 190 to be mechanically and electrically connected to the hand-held power tool 100.

The battery pack 190 comprises a housing 195. The battery pack 190 is designed as a sliding battery pack that can be inserted into the battery pack interface 117 along its longitudinal extension or in the axial direction 102 of the battery pack 190. Furthermore, the battery pack 190 comprises an operator element 192 configured so as to unlock the battery pack 190 from the battery pack interface 117.

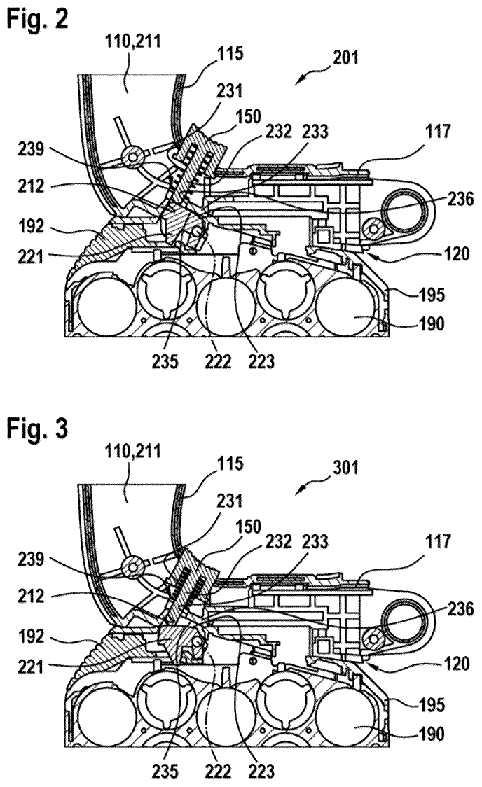

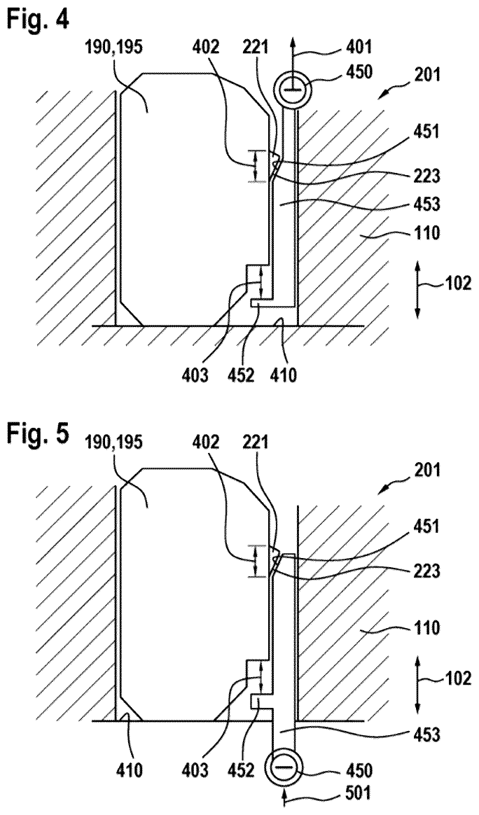

According to the invention, an operator element 150 (or 450 in FIG. 4 and FIG. 5) is arranged on the housing 110 in order to impinge on a locking element (211 in FIG. 2) of the battery pack 190 for unlocking the battery pack 190 from the battery pack interface 120. Preferably, the operator element 150 (or 450 in FIG. 4) is configured so as to directly impinge on the locking element (211 in FIG. 2). Preferably, the operator element 150 is arranged on the handle 115.

Thus, the battery pack 190 can be unlocked at least additionally via the operator element 150 provided on the housing 110 of the electrical device 100, e.g. if the operator element 192 of the battery pack 190 is sluggish. Furthermore, the battery pack 190 can optionally be enclosed in an associated housing, e.g. for improved battery protection, and still be unlocked in a user-friendly manner by providing the additional operator element 150.

According to one embodiment, the operator element 150 (or 450 in FIG. 4) is manually actuated by a user of the electrical device 100. Alternatively or optionally, an actuator can be provided for automatically actuating the operator element 150 (or 450 in FIG. 4). After actuation of the operator element 150 (or 450 in FIG. 4), the battery pack 190 can be removed from the battery pack interface 120 without a release or grip change.

According to one embodiment, the operator element 150 is designed as a pressure switch. Preferably, the operator element 150 is arranged between the handle 115 and the receiving area 117 of the housing 110 associated with the battery pack interface 120.

FIG. 2 shows the battery pack 190 of FIG. 1 arranged on and locked to the battery pack interface 120 of the housing 110 of FIG. 1. Preferably, the housing 110 comprises two housing half-shells 211, wherein only one housing half-shell 211 is shown in FIG. 2.

The battery pack 190 is associated with a locking element 221 via which the battery pack 190 can be locked to the battery pack interface 120 and thus to the housing 110. The locking element 221 is preferably mounted in a linearly and/or rotationally movable manner in or on the housing 195 of the battery pack 190.

Illustratively, the locking element 221 is supported in a rotatably moveable manner on the housing 195 of the battery pack 190. For this purpose, the locking element 221 is rotatably supported on the housing 195 via a rotation axis 222. Preferably, the locking element 221 is configured so as to be connected in a force-fit and/or form-fit manner, in particular via an undercut, of the battery pack 190 to the hand-held power tool 100.

In its position shown in FIG. 2, the locking element 221 is arranged in sections in a receptacle 212 of the housing 110. Here, a top side 235 of the locking element 221 facing the housing 110 abuts a housing rib 236 associated with the receptacle 212, in particular a side 235 of the housing rib 236 that faces the battery pack 190. Preferably, the housing rib 236 has a recess 233 that penetrates the operator element 120 in the unlocking position (301 in FIG. 3) for unlocking the battery pack 190.

Furthermore, FIG. 2 shows the operator element 150 configured so as to impinge on the locking element 221 for unlocking the battery pack 190. According to the embodiment shown, the operator element 150 directly impinges on the locking element 221. In FIG. 2, the operator element 150 is arranged in a rest position 201. Preferably, the operator element 150 is impinged via a spring element 231 into the rest position 201.

Furthermore, the housing 110 forms a guide region 239 for guiding the operator element 150. For this purpose, the operator element 150 preferably comprises a pin-shaped impingement portion 232. The pin-shaped impingement portion 232 is arranged in the rest position 201 within the housing 110. Preferably, the operator element 150 is arranged on an side opposite the battery pack interface 120, in sections, outside of the housing 110. Optionally, the battery pack 190 can be biased on the battery pack interface 120 by an additional spring element for ease of removal in a corresponding removal direction.

FIG. 3 shows the battery pack 190 of FIG. 1 and FIG. 2 arranged on the housing 110 in an unlocking position 301. In the unlocking position 301, the operator element 150 is illustratively actuated in the direction of the battery pack 190. In doing so, the spring element 231 is compressed and the pin-shaped actuation section 232 is arranged in a displaced manner along the guide region 239. The pin-shaped actuation section 232 partially penetrates the recess 233 of the housing 110. Here, the locking element 221 is rotated on its top side 223 into an unlocking position by the pin-shaped actuation section 232 of the operator element 150. The locking element 221 is positioned in the unlocking position in the housing 195 of the battery pack 190 so that the battery pack 190 can be removed from the battery pack interface 120.

FIG. 4 shows the housing 110 of FIG. 1 and FIG. 2 with a receiving compartment 410 for a battery pack 190 designed as a plug-in battery pack and with an alternative operator element 450 associated with the housing 110 for unlocking the battery pack 190. The operator element 450 is illustratively shown in the rest position 201.

The operator element 450 is preferably designed as a slider switch that can be moved into the unlocking position 301 via a linear pulling motion along an arrow 401. The operator element 450 can be moved by a pushing or pulling motion counter to or along the arrow 401.

Preferably, the operator element 450 comprises a ramp-like impingement portion 451 configured so as to impinge on the locking element 221 of the battery pack 190 locked to the battery pack interface 120. As a result of the pulling motion along arrow 401 or along the longitudinal extension 102 of the battery pack 190 to unlock the battery pack 190 from the housing 110, the locking element 221 is moved by the ramp-like operator element 450 from the locked position shown into the unlocking position.

Furthermore, the operator element 450 comprises a carry-along element 452. Preferably, the carry-along element 452 is rigidly connected to the operator element 450. By way of example, the carry-along element 452 and the operator element 450 are integrally formed with each other. Alternatively, it would also be conceivable that the carry-along element 452 is movably connected to the operator element 450, for example in the form of a lever. Preferably, the driver element 452 is configured so as to impinge on the battery pack 190 with a force during the pulling motion of the operator element 450. Advantageously, the battery pack 190 can be moved in the removal direction by this force. By way of example, the impingement portion 451 and the carry-along element 452 are arranged separately from one another on the operator element 450. However, it would also be conceivable that the driver element 452 and the impingement portion 451 are integrated into each other. Preferably, a travel distance 403, or a distance between the carry-along element 452 and the battery pack 190, is greater than an axial length 402 of the locking element 221 of the battery pack 190 to be impinged on along the removal direction.

FIG. 5 shows the battery pack 190 configured as a plug-in battery pack in the receiving shaft 410 of FIG. 4, with an alternative operator element 450. The operator element 450 is configured analogously to the operator element 450 of FIG. 4 with a, for example, ramp-like impingement portion 451 and with the carry-along element 452, however, the operator element 450 is movable into the unlocking position 301 by a pushing motion along an arrow 501.

1. An electrical device, comprising:
a housing;
a battery pack interface on which a battery pack can be locked via a locking element associated with the battery pack; and
an operator element is arranged on the housing for and configured to directly impinge on the locking element of the battery pack in order to unlock the battery pack.

2. The electrical device according to claim 1, wherein the operator element is arranged on a handle formed by the housing.

3. The electrical device according to claim 1, wherein the operator element is configured to be impinged into a rest position via a spring element.

4. The electrical device according to claim 1, wherein the housing is configured to form a guide portion for guiding the operator element.

5. The electrical device according to claim 2, wherein the operator element is configured as a pressure switch and is arranged between the handle formed by the housing and a receiving area of the housing associated with the battery pack interface.

6. The electrical device according to claim 1, wherein:
the operator element is configured as a sliding switch, and
the operator element is further configured to be movable into an unlocking position via a linear push or pull movement.

7. The electrical device according to claim 6, wherein the operator element comprises a ramp-like impingement portion configured to impinge on the locking element of the battery pack locked to the battery pack interface.

8. The electrical device according to claim 6, wherein the operator element comprises an end stop configured so as to limit a travel distance of the operator element during a movement from a rest position into the unlocking position.

9. The electrical device according to claim 8, wherein the travel distance is greater than an axial length of the locking element of the battery pack locked to the battery pack interface, which locking element is to be impinged.

10. The electrical device according to claim 1, further comprising the battery pack, wherein:
the operator element is configured so as to impinge on the locking element of the battery pack arranged on the battery pack locked to the battery pack interface, and
the battery pack comprises a second operator element configured to actuate the locking element of the battery pack.

11. The electrical device according to claim 10, wherein the operator element of the electrical device is configured so as to directly impinge on the locking element of the battery pack.

12. The electrical device according to claim 10, wherein:
the battery pack includes a battery pack housing, and
the locking element of the battery pack is mounted in a linearly and/or rotationally movable manner in or on the battery pack housing.

13. The electrical device according to claim 10, wherein the locking element is configured for a force-fit and/or form-fit connection of the battery pack to the electrical device.

14. The electrical device according to claim 1, wherein the electrical device is a hand-held power tool.

15. The electrical device according to claim 10, wherein the locking element is configured for a force-fit and/or form-fit connection of the battery pack to the electrical device via an undercut.
